(19) United States
(12) Patent Application Publication
(10) Pub. No.: US 2004/0064341 A1
(43) Pub. Date: Apr. 1, 2004

(54) Systems and methods for healthcare risk solutions

(76) Inventors: Pete F. Langan, Hartford, CT (US); Jeffery S. Ritz, Scituate, MA (US)

Correspondence Address: LATHROP & GAGE LC, 2345 GRAND AVENUE, SUITE 2800, KANSAS CITY, MO, 64108, US

(21) Appl. No.: 10/259,086

(22) Filed: Sep. 27, 2002

(51) Int. Cl. G06F 17/60

(52) U.S. Cl. 705/2

(57) ABSTRACT

Processes and systems collate hospital data and generate healthcare risk solutions. Hospitals electronically couple to one or more databases, through a firewall, to download hospital data. The hospital data may be processed to de-identify particular patient data. An application processes the hospital data to publish healthcare risk solutions reports to users over a network, e.g., the Internet. The healthcare risk solutions reports may include consultative solutions and one of the following: incidents, event tracking and trending; medical malpractice claim tracking and trending; cost impacts of adverse events and claims; analysis of incidents by type, dept, physician, specialty and/or shift; impact on hospital operations; and benchmarking to peer hospitals.

### BACKGROUND OF THE INVENTION

There are several serious healthcare issues that impair national health. In a first example, approximately one hundred thousand deaths and five hundred thousand unnecessary hospitalizations occur each year due to medical errors. The annual cost for such errors is immense: $17 b for preventable errors and $12 b for possibly preventable errors, versus $8.6 b for unpreventable errors. In a second example, an average employer with 10,000 employees has three avoidable deaths per year due to sub-par health care. In a third example, mean medical malpractice awards have doubled from approximately $1.5M in 1994 to approximately $3.5M in 1999.

At the same time, hospitals face increasing staff shortages, decreasing patient satisfaction, and an increasing mandate to stem rising operating costs. Certain external pressures significantly complicate these issues, including: increased regulatory measures; increased medical error reporting requirements; rising insurance premiums for nearly all sectors; unavailability of medical malpractice insurance for hospitals and doctors; increasing productivity and information demands, with parallel need for improved equipment and software; and demands for data on the performance of healthcare professionals and organizations from consumer awareness and advocacy groups, such as AARP.

FIG. 1 illustrates typical delivery and outcome scenarios associated with patient processing within a hospital. In step 10, the hospital acquires a patient through marketing, competition, scorecards and/or consumer selection criteria. In step 12, clinical procedures occur based on guidelines, staffing, reviews and assessments. Outcomes from clinical procedures are either negative or positive, as indicated by outcome branch 14. In an exemplary positive outcome, step 16, the patient leaves the hospital system and is billed. The negative outcomes are exemplified by block 18, which, for example, includes generating an incident report (step 20), engaging in legal actions (step 22), managing risk (step 24), and administrative actions (step 26). Steps 20-26 also exemplify the costs and unnecessary operations that occur due to failed or problematic clinical procedures of step 12, since a majority percentage of these operations stem from preventable or possibly preventable medical errors.

It should be apparent from the foregoing that a need exists to better evaluate patient incidences and claims to improve overall healthcare. Certain features presented hereinafter address this need by providing an interactive information technology platform that integrates clinical data with consultative resources.

### SUMMARY OF THE INVENTION

The following description advances the state of the art, for example, by providing data in the form of healthcare risk solutions; these solutions are synthesized or determined from hospital malpractice information, clinical incident information and/or hospital financial data. In one aspect, a process is provided to produce healthcare risk solutions. Hospital data is electronically collated with one or more databases, typically including a relational database. The hospital data may be de-identified, to remove patient-specific information, so as to protect patient privacy. Healthcare risk solutions are generated by an application or analysis engine in response to user requests, typically over a network.

The step of electronically collating may include networking with the hospitals and downloading the hospital data to the databases. The hospital data may for example include patient electronic medical record number, information concerning hospital incidents and adverse events, patient level billing data, medical malpractice claims information, and/or standard medical codes, defined below.

Typically, the healthcare risk solutions contain data such as (1) incidents, event tracking and trending, (2) medical malpractice claim tracking and trending, (3) cost impacts of adverse events and claims, (4) analysis of incidents by type, dept, physician, specialty and/or shift, (5) impact on hospital operations, and/or (6) benchmarking to peer hospitals. These data are defined in more detail below, and typically publish as electronic graphical reports at user terminals.

In another aspect, the healthcare risk solutions include consultative solutions and/or implementation and control data. The consultative solutions include, for example, process consulting information and risk consulting information.

User requests may be generated at terminals networked with the databases, typically through a firewall. In one aspect, the hospital data also downloads to the databases over a network, and typically through a firewall. The networks can include the Internet.

In another aspect, a system is provided to generate healthcare risk solutions. A first database stores hospital data from one or more hospitals. A network interface connects the first database to one or more users over a network. A risk solutions application processes the hospital data in response to requests of the users to generate healthcare risk solutions. One or more firewalls may protect the hospital data and the healthcare risk solutions from the users. Users of one aspect include hospital management or other management entities, as defined below.

### BRIEF DESCRIPTION OF THE DRAWINGS

FIG. 1 illustrates high level delivery and outcome scenarios for prior art patient processing within a hospital;

FIG. 2 shows one interactive system for healthcare risk solutions;

FIG. 3 shows another interactive system for healthcare risk solutions;

FIG. 4 illustrates data collation by one risk solution application;

FIG. 5 shows one process illustrating data input and analysis to produce healthcare risk solutions in accord with the teachings herein; and

FIG. 6. schematically illustrates transformation and use of hospital data in accord with the improvements provided by the systems and methods of FIG. 2, FIG. 3 and FIG. 5.

### DETAILED DESCRIPTION OF THE DRAWINGS

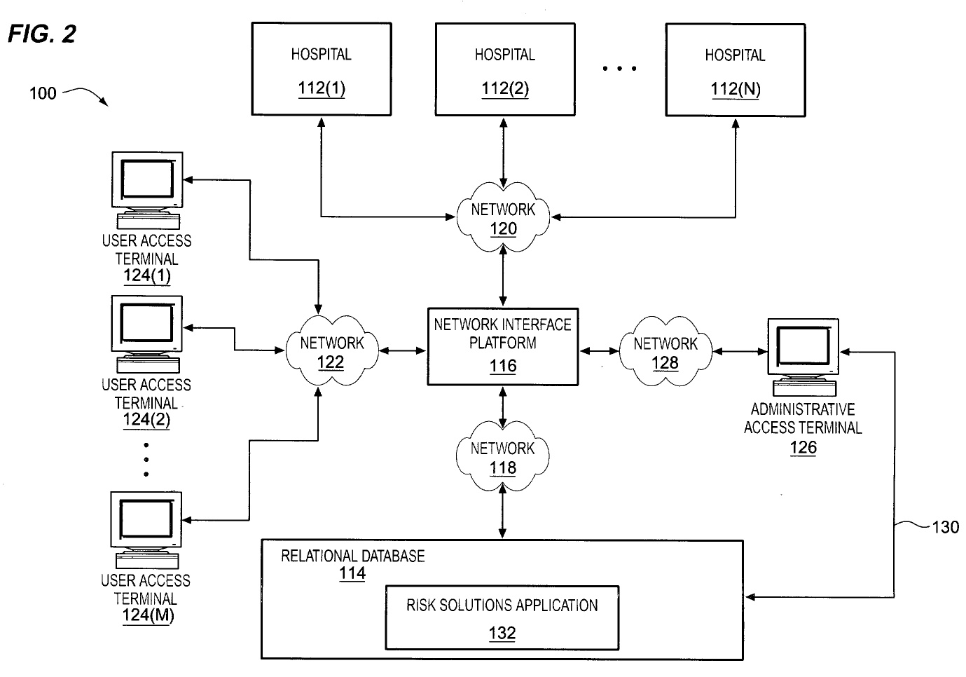

FIG. 2 shows a system 100 that connects to and communicates with one or more hospitals 112 (shown as hospitals 112(1), 112(2) . . . 112(N), for purposes of illustration) to download data to a relational database 114. The interface between hospitals 112 and database 114 may include a network interface platform 116, such as a web platform, that connects via networks 118, 120, as shown. Network 118 is, for example, a local area network; network 120 is, for example, the Internet. Networks 118,120 may include firewalls, as discussed below.

In one embodiment, platform 116 provides an interactive interface to data within database 114. More particularly, users of system 100 may connect to platform 116 via a network 122 (e.g., the Internet) and one or more remote access terminals 124 (shown as terminals 124(1), 124(2) . . . 124(M), for purposes of illustration) to access and process data within database 114. Each of terminals 124 may thus include graphical user interface (“GUI”) software to facilitate such access and process actions.

Administrative access and control of database 114 may occur through an administration terminal 126. Terminal 126 may also connect to platform 116 through a network 128 (e.g., the Internet) or through a bus connection 130 to database 114, as shown.

In one embodiment, database 114 includes a risk solutions application 132, to process data within database 114 and to respond to user requests at terminals 124, 126. Data downloaded from hospitals 112 to database 114 may for example include (1) patient electronic medical record number, (2) information concerning hospital incidents and adverse events, such as near misses and non-medical events, (3) patient level billing data, (4) medical malpractice claims information, and/or (5) other data, including demographics on the hospital, doctor, patient, and/or standard medical codes. The standard medical codes for example include diagnosis related group (“DRG”), current procedural terminology (“CPT”), international classification of diseases, 9^{th} revision (“ICD-9”), and healthcare procedural coding system (“HCPCS”). Those skilled in the art should appreciate that application 132 can optionally exist and operate as a stand-alone application external to database 114, for example using database query application programming interfaces, without departing from the scope hereof.

Application 132 processes the multi-hospital data, for example, to produce the following analyses, reports and/or graphical information characterizing hospitals 112: (1) incidents and event tracking and trending, (2) medical malpractice claim tracking and trending, (3) cost impacts of adverse events and claims, (4) analysis of incidents and claims by type, dept, physician, specialty, shift, and/or the standard medical codes, (5) impact of the analysis of incidents on hospital operations, such as risk-adjusted length of stay (“LOS”) and other clinical or operational costs, and/or (6) benchmarking to peer hospitals (through demographic information) on topics of incidents, claims and operational costs. The information generated by application 132 may display graphically at a terminal 124, 126, publish through printing, and/or store as an electronic file, for example.

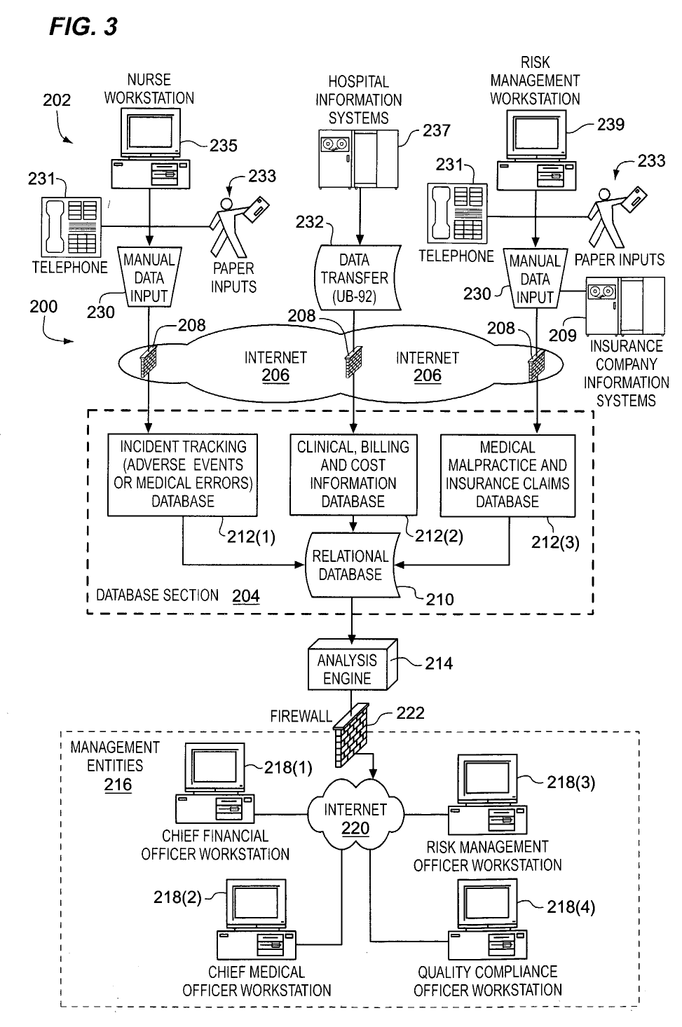

FIG. 3 illustrates a system 200 for implementing healthcare risk solutions in accord with certain teachings herein. For purposes of illustration, system 200 is shown connected with a single hospital 202; however additional hospitals may also connect with system 200 in similar fashion and without departing from the scope hereof. Hospital 202 connects with a database section 204 through a network such as the Internet 206. A firewall 208 may protect the integrity of this connection, as illustrated. Third party insurance information systems 209 typically also connect to hospital 202 through Internet 206 and firewall 208 to provide insurance functions.

In one embodiment, database section 204 includes a relational database 210. One or more additional databases 212 may also be included within section 204, including an incident tracking database 212(1), clinical information database 212(2), and malpractice database 212(3).

An analysis engine 214 connects with section 204 to process data, from hospital 202 and/or other hospitals, for management entities 216. Entities 216 may for example include management workstations 218, such as financial officer workstation 218(1), medical officer workstation 218(2), risk management officer workstation 218(3), and quality compliance officer workstation 218(4). Workstations 218 may be distributed at various physical locations and connect to database section 214 through a network 220, such as the Internet, and a firewall 222, as shown. Firewall 222 can facilitate patient record privacy, such as governed by the Healthcare Insurance Portability and Accountability Act (“HIPAA”). In one example, firewall 222 permits access to defined information within relational database 210 and/or defined features of analysis engine 214 by authorized persons possessing passwords for such features and information

Databases 212 may provide point solutions for hospital 202. For example, within its own institution, hospital 202 may utilize database 212(1) to track incidents and adverse events; it may utilize database 212(2) to track clinical, billing and cost information; it may further utilize database 212(3) to track malpractice claims. In the prior art, databases 212 were not however interconnected—and/or data only existed as hard paper documents—so that analyses of data from databases 212 could not be effectively processed. In FIG. 3, databases 212 are electronic and connect through relational database 210 so as to interrelate data within databases 212. In accord with the teachings herein, databases 212 need not reside in separate servers, but instead may exist as data on a single server or distributed over a number of server systems. Processing applications may be integrated within the database management systems or may be implemented as stand-alone software applications coupled to the databases. Further, all dedicated databases may be implemented as relational, hierarchical or object-oriented databases, or may be implemented using custom file indexing structures and processes.

Hospital 202 typically involves processes such as (1) manual data input 230 and data transactions 232, such as billing, diagnosis and treatment data processing. Data transactions 232 may further utilize UB-92 standard data formatting, known to those skilled in the art, so as to utilize a patient record number, demographic information, and/or the standard medical codes. As described hereinbelow, analysis engine 214 may process such data to establish and analyze trends between multiple hospitals. Data may thus be input to analysis engine 214 and/or relational database 210 manually, through input 230, or by direct extraction of data stored within information systems, e.g., databases 212. FIG. 3 also illustrates other typical processes within hospital 202, including for example telephone inputs 231 and paper inputs 233 to system 200, and network connectivity via internal nurse workstation 235, hospital information systems 237, and risk management workstation 239.

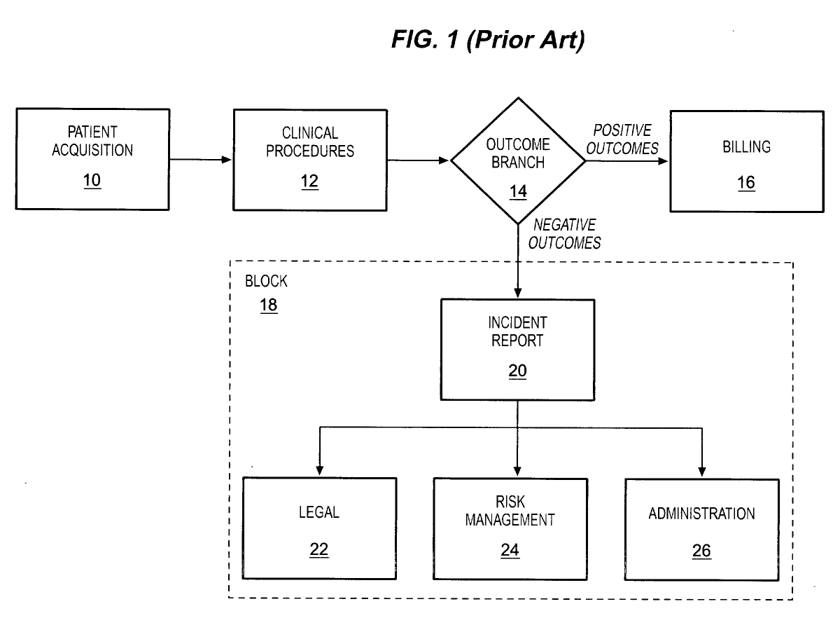

In one embodiment, therefore, database section 204 utilizes a common data element: a patient electronic medical record number (“EMR#”) and the standard medical codes (e.g., DRG, CPT, ICD-9 and HCPCS). The common data element is processed by analysis engine 214 to generate reports and analyses requested by management entities 216. Analysis engine 214 may for example include risk solutions application 132, FIG. 1, and provide like functionality. Accordingly, database 210 and engine 214 may cooperate similarly to database 114 and application 132, FIG. 1.

In one embodiment, analysis engine 214 “de-identifies” specific patient information from any of its aggregated reports or analyses, to protect particular patient information while maintaining demographic and systemic information for aggregated analysis, benchmarking, trending and/or prediction of data from databases 210, 212. Aggregated data analysis facilitates better understanding of certain risks and costs associated with patient processing within hospital 202, promoting better decision-making as to applying risk management and quality compliance resources; it may further facilitate demonstrating the impact of changes to patient processing, over time (i.e., trending), so as to reduce the costs and operations associated with negative outcomes, block 18, FIG. 1. As described in more detail below, de-identification is not typically used, or required, when the aggregated reports and analyses are made for the single hospital requesting such reports and analyses, since the patient information is already proprietary to that hospital.

More particularly, analysis engine 214 may represent the intelligence center of system 200, to extract and assemble raw data from hospital 202, and/or from other hospitals, into reports. Such reports can for example include an analysis of (1) cost of care where medical errors and/or adverse events have occurred, (2) cost of care where medical malpractice claims have occurred, (3) trending of incidents and adverse events, (4) trending of medical malpractice claims, (5) identification and monitoring of claims and events by physician, department, shift (e.g., night, day, swing shift), specialty, procedure and/or diagnosis code, and (6) tracking of claims or incidents to litigation or settlement. Data aggregation from multiple hospitals therefore allows one hospital 202 to compare its risks and patient incidences to peer hospitals—e.g., by size, patient bed number, geography, specialty, diagnosis code—while de-identification of specific patient data protects patient privacy. By way of example, hospital 202 may thus relate its risk management programs and costs to effectiveness as gauged by peer hospitals, further promoting quality of care improvements.

One advantage of system 200 is that it provides financially challenged hospitals with opportunity to implement, at lower cost, complex information technology systems such as represented by database section 204. Specifically, a hospital 202 may have functionality provided by section 204 and engine 214 without physical assets on location; hospital 202 may instead access and process data through the Internet on an as-needed basis. Moreover, administrative entities 216 can be entities of hospital 202. In such an embodiment, firewalls 208, 222 provide security between (a) low-level patient functions and data, at hospital 202, and (b) high level analysis and strategic planning associated with hospital administrative entities 216. Access to and from records of database section 204 may be monitored and recorded by analysis engine 214, for further enhancement of patient security. Accordingly, analysis engine 214 and section 204 may be operated and controlled by a third-party company in compliance with laws, regulations and peer review statutes, without risk to individual hospital security and/or patient privacy.

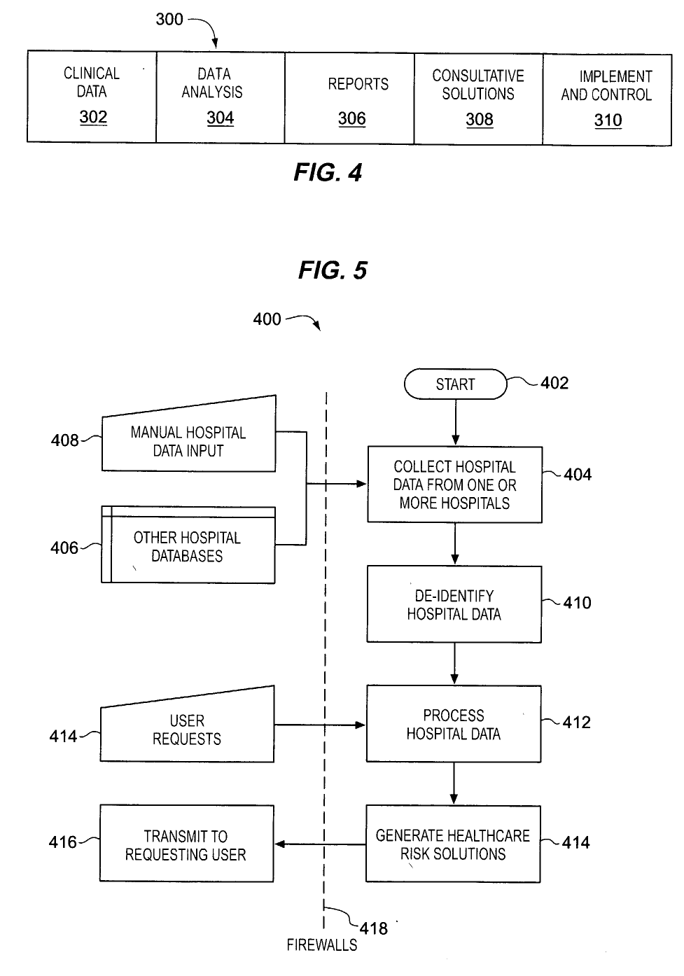

Synthesis of data from database section 204 may further create new insight as to total cost of risk and the operational impact due to negative patient outcomes, so as to identify problem areas for root cause analysis. In one embodiment, and as described in connection with FIG. 4 below, analysis engine 214 further provides quality improvement consultative solutions based on this synthesis, to provide clinical risk expertise, to assist in information analysis and understanding, to generate alternatives for addressing root causes, and/or to provide process expertise to implement and control solutions for long term quality of care improvements.

FIG. 4 illustrates data collation 300 by a healthcare risk solutions system such as described in connection with FIG. 2 and FIG. 3. Data collation 300 for example represents a solution data set produced in part by analysis engine 214, FIG. 3, or application 132, FIG. 1. A first segment of data collation 300 is clinical data 302, setting forth patient events, incidents, near-miss claims, and process reviews; data 302 may for example embody de-identified data deriving from hospital 202, FIG. 3, and/or other hospitals. A single hospital 202 may however utilize raw data, without de-identification, when data 302 concerns its own institution.

Data 302 is processed as described herein to generate analysis data 304; data 304 may for example include root causes and cost drivers associated with negative outcome patient processing. Data 304 may publish as a report 306, such as described above, and setting forth benchmarking, trending, activity and predictions for future risks and incidences. Analysis engine 214 may further generate consultative solutions data 308, such as process mapping, solution identification, and solution prioritization. Finally, data 300 may include implementation and control data 310, for example representing quality improvement methodology, and control charts and dashboards.

In summary, data 300, generated by analysis engine 214, FIG. 3 and/or application 132, FIG. 2, provides certain advantages to users such as a hospital. For example, data 300 provides evidence-based healthcare risk solutions for (1) medical error root cause identification and reduction, (2) quality of care demonstration and improvement, (3) patient safety and satisfaction, and (4) medical malpractice cost identification and solutions. Moreover, the healthcare risk solutions generated in accord with the teachings herein mitigate certain issues facing current healthcare. In a first example, healthcare organizations and practitioners are faced with increased demand for regulatory reporting and compliance regarding medical errors, near misses, adverse events and other incidents leading to patient harm or medical malpractice claims. The healthcare risk solutions presented herein provide near real-time, on-demand information supporting reporting and compliance measures. In another example, the costs and impacts associated with medical errors, near misses, adverse events and other incidents are increasing at a time when hospital financial strength is tenuous; demand for healthcare is also growing at rates above inflation, and is expecting to continue to do so as world population ages. The healthcare risk solutions presented herein reduce or eliminate unnecessary costs and procedures associated with preventable errors and events, managing the expanding cost of healthcare. In another example, consumers are becoming more aware of the need to understand the performance of organizations and practitioners providing care; there is a further awareness of variations in standards of care and in associated outcomes, and informed consumers wish to know that they have access to the best care. The healthcare risk solutions presented herein provide ready access to information about standards, compliance, trends and peer-to-peer hospital comparison. In still another example, due to the accelerated cost of jury awards and settlements from medical malpractice claims, both organizations and practitioners are facing a crisis in liability insurance; access to increasingly costly coverage is also limited, affecting the ability of organizations and practitioners to continue the practice of medicine. The healthcare risk solutions presented herein permit tracking and comparison of patient negative outcomes in a manner that facilitates problem identification and improvement, saving further costs.

FIG. 5 shows a flowchart 400 illustrating one process in accord with certain teachings herein. After start 402, “hospital data,” as hereinafter defined, is collected from one or more hospitals in step 404. Step 404 may for example include networking a relational database with the hospitals to download the hospital data to the relational database. By way of example, step 404 may include networking the relational database with hospital databases 406 used by the hospitals, and/or manually inputting 408 (e.g., by scanning) medical documents to such databases. In one embodiment, the “hospital data” of step 404 includes one or more of (1) patient electronic medical record number, (2) information concerning hospital incidents and adverse events, such as near-misses and non-medical events, (3) patient level billing data, (4) medical malpractice claims information, and/or (5) the standard medical codes.

In step 410, patient information is optionally de-identified, so as to remove particularity of person-specific information. Hospital-sensitive information may also be removed from the hospital data, in step 410. De-identification of step 410 may not occur when future transmission 416 is restricted to the hospital to which the hospital data originates, since that information, data and analysis derives from its own organization.

In step 412, and in response to user requests 414, hospital data is processed to generate 414 “healthcare risk solutions,” as hereinafter defined. An analysis engine 214, FIG. 3, and/or application 132, FIG. 2, may be used in process steps 412, 414 to generate the healthcare risk solutions. In one embodiment, user requests 414 occur through remote terminals networked with the relational database, as controlled by the analysis engine 214 and/or application 132.

In one embodiment, the “healthcare risk solutions” generated in step 414 is represented by some or all of data collation 300, FIG. 4, typically deriving from multiple hospitals. The healthcare risk solutions may also be represented by one or more of the following data elements: (1) incidents and event tracking and trending, (2) medical malpractice claim tracking and trending, (3) cost impacts of adverse events and claims, (4) analysis of incidents by type, dept, physician, specialty and/or shift, (5) impact on hospital operations, such as risk-adjusted length of stay (“LOS”) and other operational costs, and (6) benchmarking to peer hospitals on topics of incidents, claims and operational costs. More particularly, “incidents and events” are, for example, occurrences outside of hospital policy, standard procedures, or standards of care; incidents and events may or may not result in actual harm to a patient, employee or other person. “Tracking” indicates, for example, whether an incident leads to an actual claim, what impacts stem from that incident (e.g., costs and resources), and what are the contributing factors and root causes. “Trending” indicates, for example, frequency of type, location, contributing factors, cost impact, impact/effect of mitigation efforts, and/or the use of control charts over time. “Medical malpractice claim tracking and trending” for example monitors the progress of a claim as it develops, including the costs and resources applied to it, the impacts on operations and personnel, and the severity and final outcome. “Trending claims” identify, for example, frequency, location, and/or contributing factors; they further may facilitate understanding of the impact and effect of maneuvers to minimize or eliminate specific kinds of claims. “Cost impacts of adverse events and claims” indicate, for example, financial metrics associated with unnecessary processes and procedures created when such impacts and events occur, and the cost structures that might have been if the impacts and events had been prevented, minimized and/or better controlled. “Type of incident” classifies an event, for example as caused by a fall or medication. “Department” for an incident defines, for example, a place of occurrence, such as the hospital intensive care unit, emergency room, and/or operating room. “Physician” for an incident defines, for example, the doctor attending the patient. “Specialty” for an incident defines, for example, a clinical specialty under treatment, such as cardiovascular, renal, and/or other areas. “Shift” means, for example, a day, night, third, or holiday work period. “Impact on hospital operations” for example relates to an understanding of numbers such as LOS in relation to patient demographics (e.g., age, sex, morbidity, co-morbidity, tests), attending physician, and other events (e.g., medication errors may indicate a 50% longer stay) so as to better understand the costs and utilization effects of certain events or decisions; physicians may use different standards of time of stay other than LOS. “Risk-adjusted LOS” defines, for example, a number of days from admittance to discharge; LOS may be impacted by many decisions, events or standards of care. “Benchmarking to peer hospitals” on topics of incidents assists, for example, in comparing hospitals to one another; hospital peers are cohorts by demographics—e.g., suburban versus urban, for profit versus government, one hundred beds versus five hundred beds, children versus osteopathic—that may also create segmentation.

With further regard to FIG. 5, step 416, healthcare risk solutions are transmitted to the requesting user. Typically, as above, this user is networked with the relational database and in control of the analysis engine 214, FIG. 3, and/or application 132, FIG. 2. The healthcare risk solutions may be published, for example, as graphical data through a graphical user interface at the terminal operated by the requesting user. These requesting users may for example include management entities, such as persons assessing the financial health of the hospitals contributing to step 404.

Information flow between 404, 410, 412, 414 and 406, 408, 414, 416 preferably occurs through a firewall 418 to protect patient and hospital integrity. Firewall 418 facilitates this protection since healthcare risk solutions transmitted 416 to requesting users typically includes collation of hospital data from multiple hospitals and multiple patients.

Data collation 300 of FIG. 4 may also illustrate a process flow of healthcare risk solutions, from step 302 to step 310. The process starts with the collection of data from clinical events (step 302), including medical malpractice claims, adverse incidents, and patient records. These event data are captured by systems (such as systems 100, 200 of FIG. 1, 2, respectively) in various formats: paper hard copies, electronic spreadsheets, client/server applications and/or web-based relational databases. Event data may for example be entered to the system by one of several techniques: by manual or direct data entry, by database mapping with batch transfer in comma delineated format (.csv), and/or via Internet Protocol (IP) electronic transfers. Analysis step 304 may for example group events by type of incident or claim, type of hospital, specialty, physician, etc., and trend this information over time. In one embodiment, the cost associated with events is also included to better identify financial impacts and importance. Analysis step 304 may include a clinical algorithm to “severity adjust” the data, to account for the initial condition or other critical demographic variables that might otherwise bias the analysis. Reporting step 306 may include a standard output of analysis step 304, and/or may include business software analysis using Java or other open computing languages to customize data viewing. Accordingly, step 306 may create a set of pre-defined standard reports that are created automatically to meet the user's needs, and/or “ad hoc” reports. Consultative solutions step 308 may be used by management to (a) review reports of step 306, (b) prioritize impacts, (c) map clinical processes, (d) identify potential solutions, and/or (e) select a course of action to achieve the desired result. These consultative solutions are implemented (step 310) and control features are created (step 310) to include statistical process control charts and other data analysis reports (step 306) that monitor the solutions and associated impacts.

With further regard to FIG. 5, process 400 may formulate a normalized database of clinical information such as process flow 300. Input steps 406 and 408 may accommodate various protocols, including manual data, spreadsheets, comma delineated batch transfer, or Internet Protocol (IP) data transfers. Inputs 406, 408 may be transmitted through a secure firewall 418 for data and personal security, so as to require user name and password, encryption, and/or other secure protocol. In step 404, data from steps 406, 408 is for example standardized into a normalized relational database, data-mart or data warehouse, and aggregated by connection to certain data elements, such as electronic medical record number, claim number, hospital identification number, and/or diagnosis or treatment codes. The de-identification of this data (step 410) may further involve the removal of data elements that would facilitate determining the source of the information, such as the electronic medical record number, patient name, or hospital name and address; nonetheless, in one embodiment, that information remains part of the underlying process step 312 to facilitate benchmarking and aggregation purposes without reporting (step 416) that information to users. Specifically, analysis processes 412, 304 may be performed with sensitive data and without communicating that sensitive data to unauthorized viewers via transfer steps 414, 416 through a secure and protected firewall connection 418.

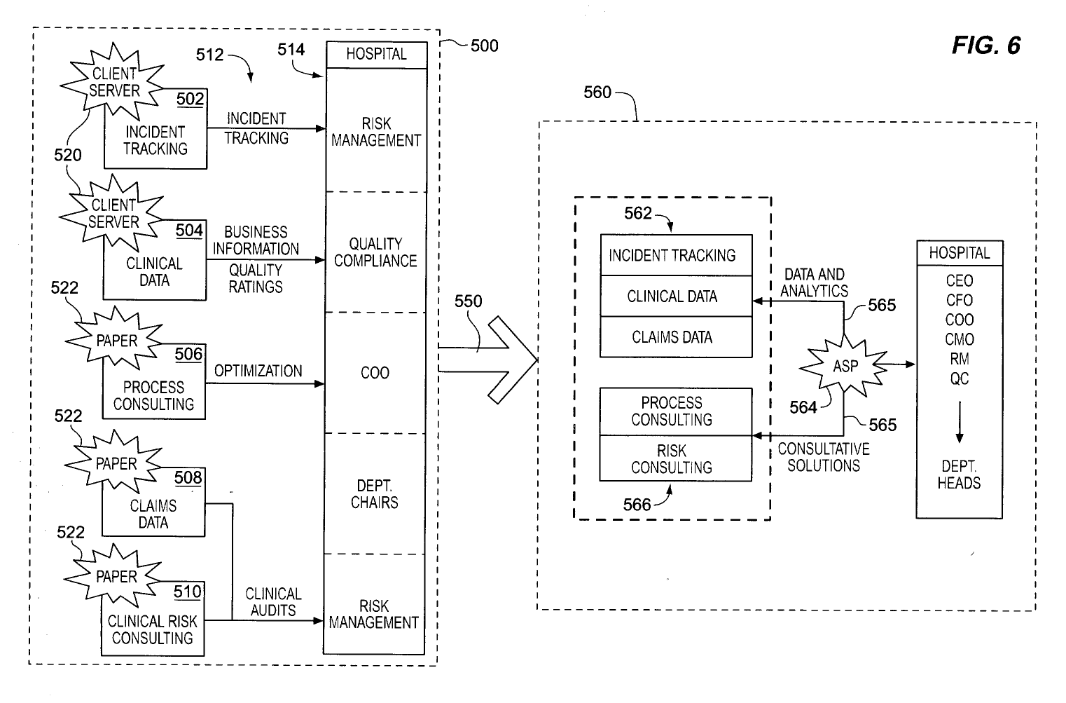

FIG. 6 illustrates how the systems of FIG. 2 and FIG. 3 simplify and streamline processing of hospital data as compared to the prior art. Block 500 represents current processing of data related to claims, events, clinical data, and financials (i.e., incident tracking data 502, clinical data 504, process consulting 506, claims data 508, and clinical risk consulting 510) for input 512 to hospital management 514. Input 512 is complicated since data 502-510 is not synthesized and derives from client servers 520 and paper sources 522, as shown. Accordingly, each such data 502-510 is generally relegated to select departments of management 514, and data processing depends on disparate systems to collect, store and analyze the data. This makes aggregation and sharing of the data difficult or impossible, and thus neither middle nor senior management 514 acquires a strategic picture of current status or trends related to medical malpractice claims, adverse events or near misses, for example.

By way of comparison and example, systems and processes of FIG. 2, FIG. 3, FIG. 5 may therefore transform 550 block 500 to an aggregated and integrated information technology platform 560. Platform 560 facilitates collection and analysis of complete hospital data 562 to reveal appropriate and significant insight into the nature and causes of events, incidents and claims. An application service provider (“ASP”) 564 such as analysis engine 214, FIG. 3, or application 132, FIG. 2, processes 565 hospital data 562 and provides consultative information 566, such as healthcare risk solutions or data collation 300, FIG. 3. ASP 564 further networks with management entities 568 so that appropriate organizations and management teams have the ability to seamlessly and quickly synthesize hospital data to monitor the afore-mentioned healthcare issues and to effect change.

In one embodiment, ASP 564 is a central server, such a Microsoft SQL or IBM Websphere server. ASP 564 may for example function via Internet Protocol (IP) and use various applications or databases. Such applications may be written in any number of programming languages, and may further utilize Java and/or XML residing on an Oracle database. Analysis engine 214, FIG. 3, and/or other reporting applications for reporting step 306 may also be hosted at ASP 564. In one embodiment, ASP 564 is protected by a firewall and secure, public key encryption (e.g., 128-bit).

Since certain changes may be made in the above methods and systems without departing from the scope hereof, it is intended that all matter contained in the above description or shown in the accompanying drawing be interpreted as illustrative and not in a limiting sense. It is also to be understood that the following claims are to cover generic and specific features described herein.

What is claimed is:

1. A process for healthcare risk solutions, comprising the steps of:
electronically collating hospital data within a database from two or more hospitals;
automatically de-identifying the hospital data to protect patient privacy; and
generating healthcare risk solutions in response to user requests to the database.

2. A process of claim 1, the step of electronically collating comprising networking with the hospitals and downloading the hospital data selected from the group of: patient electronic medical record number, information concerning hospital incidents and adverse events, patient level billing data, medical malpractice claims information, and standard medical codes.

3. A process of claim 2, the standard medical codes comprising one or more of EMR#, DRG, CPT, ICD-9 and HCPCS.

4. A process of claim 1, the step of generating healthcare risk solutions comprising the further step of generating consultative solutions.

5. A process of claim 4, the consultative solutions comprising one or more of process consulting information and risk consulting information.

6. A process of claim 1, the step of generating healthcare risk solutions comprising the further step of generating implementation and control data.

7. A process of claim 1, further comprising the step of generating the user requests from one or more management entities networked with the database.

8. A process of claim 1, the step of generating healthcare risk solutions comprising utilizing an application service provider coupled with the database over a network.

9. A process of claim 1, the step of generating healthcare risk solutions comprising utilizing an analysis engine networked with the database.

10. A process of claim 1, the step of generating healthcare risk solutions comprising utilizing a software application with the database.

11. A process of claim 1, further comprising the step of downloading the hospital data from the hospitals through a firewall.

12. A process of claim 1, further comprising the steps of transmitting the healthcare risk solutions to a terminal of a user submitting the user requests and through a firewall.

13. A process of claim 12, further comprising the step of interfacing with the user through the Internet.

14. A process of claim 1, the step of generating healthcare risk solutions comprising generating data elements selected from the group of: incidents; event tracking and trending; medical malpractice claim tracking and trending; cost impacts of adverse events and claims; analysis of incidents by type, dept, physician, specialty and/or shift; impact on hospital operations; and benchmarking to peer hospitals.

15. A process of claim 14, the step of generating healthcare risk solutions comprising electronically publishing the healthcare risk solutions as electronic graphical reports at one or more user terminals.

16. A process of claim 1, further comprising downloading the hospital data through a UB-92 data transfer to the database.

17. A system for healthcare risk solutions, comprising:
a first database for storing hospital data from one or more hospitals;
a network interface for connecting the first database to one or more users over a network; and
a risk solutions application for processing the hospital data in response to requests of the users to generate healthcare risk solutions.

18. A system of claim 17, further comprising one or more firewalls for protecting the hospital data and the healthcare risk solutions from the users.

19. A system of claim 17, the users comprising one or more management entities.

20. A system of claim 17, further comprising at least one administrative access terminal for managing one or both of the first database and the healthcare risk solutions.

21. A system of claim 17, the first database comprising a relational database.

22. A system of claim 17, further comprising one or more hospital databases networked with the first database, the hospital databases and the first database collectively storing the hospital data.

23. A system of claim 22, the hospital databases comprising one or more of (1) an incident tracking database, (2) a clinical, billing and cost information database, and (3) a medical malpractice insurance claims database.

24. A system for processing hospital data into healthcare risk solutions, comprising:
one or more databases for storing the hospital data;
means for processing the hospital data into healthcare risk solutions; and
means for protecting data transfers of the hospital data and the healthcare risk solutions to terminals networked with the databases.

25. A system of claim 24, the one or more databases comprising one or more of a relational database, an incident tracking database, a clinical, billing and cost information database, and a medical malpractice insurance claims database.

26. A system of claim 24, the means for processing comprising one or more of a risk solutions application, an analysis engine, and an application service provider.

27. A system of claim 24, the means for protecting the data comprising one or more of a firewall and network password protocol.

28. A system of claim 24, the means for processing comprising means for generating consultative solutions based on the hospital data.

29. A system of claim 24, further comprising means for de-identifying the hospital data.

30. A system of claim 24, the means for processing comprising means for producing a data collation comprising a synthesis of one or more of: the hospital data, analysis data, healthcare risk solutions reports, consultative solutions, and implementation and control information.
